(19) United States
(12) Patent Application Publication
(10) Pub. No.: US 2013/0141663 A1
(43) Pub. Date: Jun. 6, 2013

(54) Liquid Crystal Display and Making Method Thereof

(71) Applicants: Poshen Lin, Shenzhen (CN); Liangchan Liao, Shenzhen (CN); Yong Zhang, Shenzhen (CN)

(72) Inventors: Poshen Lin, Shenzhen (CN); Liangchan Liao, Shenzhen (CN); Yong Zhang, Shenzhen (CN)

(21) Appl. No.: 13/378,738

(22) PCT Filed: Dec. 7, 2011
(86) PCT No.: PCT/CN2011/083654

§ 371 Date: Dec. 16, 2011

(30) Foreign Application Priority Data
Dec. 2, 2011 (CN) 2011103963214

(51) Int. Cl. G02F 1/1333; H01J 9/00

(52) U.S. Cl. 349/58; 445/24

(57) ABSTRACT

The present invention discloses a liquid crystal display (LCD) and a making method thereof. The LCD comprises: a LCD panel and one or more (Chip on Film) COFs arranged at the edge of the LCD panel, wherein conducting layers used for discharging the static electricity from the LCD panel are arranged between the LCD panel and the COF. With the application of the conducting layers, the static electricity can be discharged from the LCD panel, and thus a LCD frame can be made of nonmetallic materials with low cost. Thereby, the production cost of the LCD can be further reduced while the static charge on the LCD panel is discharged in time.

### TECHNICAL FIELD

The present invention relates to the field of displays, in particular to liquid crystal display (LCD) and making method thereof.

### BACKGROUND

The LCD usually comprises a frame, a LCD panel 4, a plurality of source COF1 (Source COF, wherein COF is known as Chip On Film) and a plurality of gate COF2 (Gate COF), wherein IC chips are arranged in COF and are connected with COF pins.

As shown in FIG. 1, taking the LCD comprising four source COF1 and two gate COF2 as an example, a plurality of source COF1 and gate COF2 (Gate COF) are usually arranged at the top side and the edges of the LCD panel 4 respectively. A static discharge experiment needs to be carried out during the LCD product test. In the static discharge experiment, the static discharge is performed around the LCD panel by an ESD gun, and thus a lot of static charges are accumulated on the LCD panel 4; certain static charge is also accumulated on the LCD panel even if the static discharge experiment is not carried out. Therefore, in order to discharge the static electricity from the LCD panel, the LCD adopts a frame made of metal as a static discharging path to discharge the static electricity (to a backplane or an appliance conducted to the ground wire). However, the production cost of the LCD is increased by using the metal frame.

If other nonelectric frames are adopted, the static charge on the LCD panel cannot be directly discharged in time, and the LCD panel has no static discharging path; thus, with accumulation of static charge, the static electricity may be conducted to the IC on the COF along the COF laid at the edges of the LCD panel, and the Source IC, Gate IC and electronic parts connected with the IC are damaged as a result.

### SUMMARY

The aim of the present invention is to provide a low-cost liquid crystal display (LCD) capable of discharging static charge from a LCD panel, and a making method thereof.

The purpose of the present invention is achieved by the following technical schemes.

A LCD, comprising: a LCD panel and COFs arranged at the edges of the LCD panel, wherein conducting layers used for discharging the static electricity from the LCD panel are arranged between the LCD panel and the COF.

Preferably, said conducting layers are a metal layer. This design not only can low the cost, but also has the advantage that the surface temperature of the IC of the COF can be effectively decreased because the thermal conductivity coefficient of the COF is very large due to the metal layer on the COF.

Preferably, said conducting layers are arranged at the periphery of the LCD panel; at least one COF is provided with the conducting layer, and the conducting layers at the periphery of the LCD panel are mutually connected with the conducting layers on one or more COFs.

Preferably, four conducting layers on one or more COFs are respectively arranged at the four sides of the LCD panel. This design has the advantages of good conductive effect and more convenient processing.

Preferably, said conducting layers are arranged between each COF and the LCD panel.

Preferably, said conducting layers are arranged at the corresponding side of each COF and the LCD panel, and at both sides adjacent to this corresponding side. The conducting layers are only arranged at the corresponding side of each COF and the LCD panel, and at both sides adjacent to this corresponding side, so that the materials are saved while the conductive effect is ensured.

Preferably, the conducting layers on all the COFs at one side of the LCD panel and one corresponding side of the LCD panel are an integral metal layer. Because all the COFs at one side shares one metal layer, thereby the making process is simple.

Preferably, said conducting layers are composed into a metal layer covering the whole surface of the COF. This design can further raise the effect of static leakage, and decrease the surface temperature of the IC of the COF.

Preferably, the electronic chip is arranged at one side of the COF, and said conducting layers are arranged at another side of the COF corresponding to the side on which the electronic chip is arranged. This design can more preferably protect the electronic chip on the COF.

A LCD making method, comprising: the steps for installing conducting layers between a LCD panel and one or more COF, so as to discharge static electricity from the LCD panel.

Preferably, said conducting layers are directly attached to the COF when the COF is manufactured. This design can further simplify the whole making process.

The invention adopts the conducting layers between the LCD panel and the COF, so that the static electricity can be discharged from the LCD panel through the conducting layers; thus, the LCD frame can be made of nonmetallic materials with low cost, and the production cost of the LCD is further reduced while the static charge on the LCD panel is discharged in time.

### DESCRIPTION OF FIGURES

FIG. 1 is a structural diagram of the frame of the LCD in prior art;

FIG. 2 is a structural diagram of the LCD in the embodiment 1 of the present invention;

FIG. 3 is a structural diagram of the LCD in the embodiment 2 of the present invention;

FIG. 4 is a structural diagram of the LCD in the embodiment 3 of the present invention;

FIG. 5 is a structural diagram of the COF;

FIG. 6 is a schematic diagram of assembly of the COF.

Wherein: 1.source COF; 2. gate COF; 3. frame; 4.LCD panel; 5. PCB; 7.metal conducting layer; 10.integrated circuit (IC); 12.COF.

### DETAILED DESCRIPTION

The present invention is further described by figures and the preferred embodiments as follows.

The LCD comprises: a frame, a LCD panel arranged in the frame, and COF arranged at the edge of the LCD panel, wherein conducting layers used for discharging the static electricity from the LCD panel are arranged between the LCD panel and the COF. The LCD frame can be made of nonmetallic materials, preferred as plastic and other polyester materials. At the same time, the conducting layers used for discharging the static electricity from the LCD panel are partially arranged at the periphery of the LCD panel or totally arranged between the LCD panel and the COF. Therefore, when the static discharge experiment is carried out, the conducting layers can be used to discharge the accumulated charges, which prevent Source IC, Gate IC and electronic parts connected with IC from being damaged by the accumulated charges conducted to IC through the COF pins. In addition, instead of a large number of metal materials, the nonmetallic fame is made of plastic, polyester or other nonmetallic materials with low cost, so that the production cost of the LCD is saved. If the conducting layers are made of metal, the metal layer arranged on the COF can provide additional heat dissipating paths to effectively dissipate the heat generated by the COF in time because the metal is a good heat conductor; thus, the electronic parts on the COF is preferably protected, and the service life of the electronic parts is prolonged, and the safety factor of the electronic parts is improved.

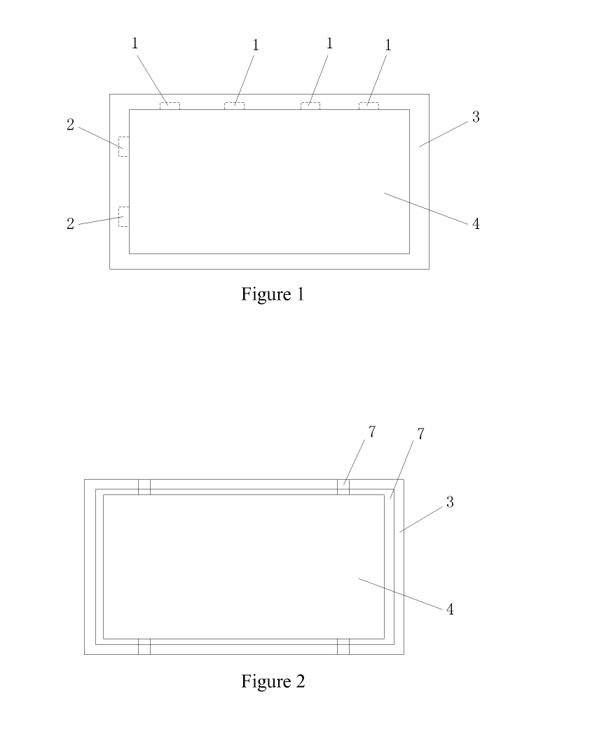

FIG. 2 shows the first embodiment of the present invention. As shown in FIG. 2, taking the LCD comprising four source COF1 and two gate COF as an example, the frame 3 is made of plastic and also can be made of other polymers; a metal conducting layer 7 made of metal conductive materials are totally arranged at the periphery of the LCD panel 4 and at both sides of four COF12 (source COF1 and gate COF2) on the four corners of the LCD panel 4 in a bonding or sticking mode and the like; the metal conducting layer 7 on the LCD panel 4 is connected with the metal conducting layer 7 on the COF, and the metal conducting layer 7 is arranged at another side of the COF12 corresponding to the side where the electronic chip IC is arranged. Therefore, the electronic chip on the COF is preferably protected, and the metal conducting layer 7 is avoided to conduct the electric charges to COF12 pins so as to further avoid conduction of the electric charges to IC and electronic parts connected with IC through COF12 pins. In the static discharge experiment, the accumulated electric charge can be discharged in time by the metal conducting layer 7, so that the safety of the IC and the electronic parts connected with the IC is protected. Because the metal conducting layer 7 is totally arranged at the periphery of the LCD panel 4 and contacts with the COF12, the conducting layer 7 connected with the conducting layer on the LCD panel 4 only needs to be arranged at one COF12; thereby, more materials can be saved, and some process steps can be omitted.

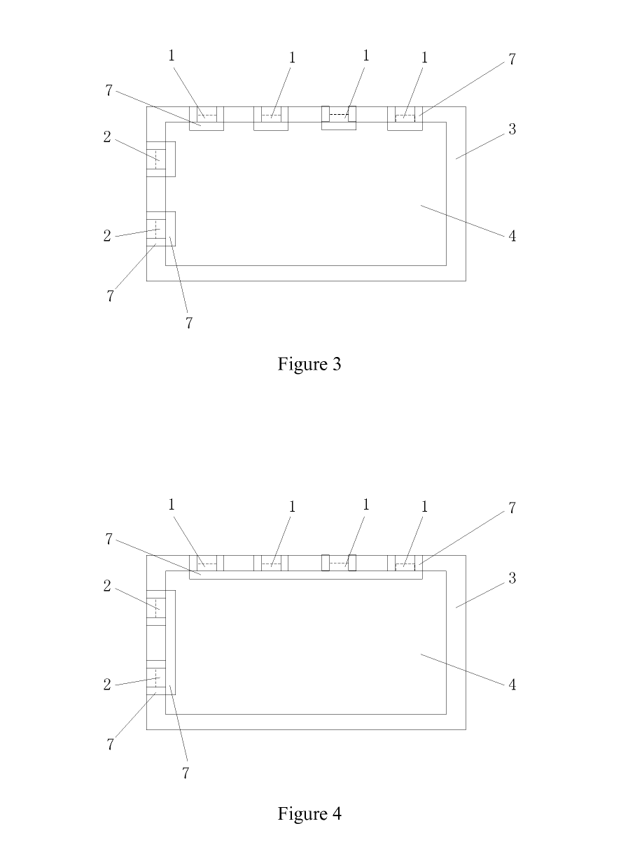

FIG. 3 shows another embodiment of the present invention. As shown in FIG. 3, in order to save the metal materials, only the periphery of the LCD panel 4, in which the COF12 (source COF1 and gate COF2) is arranged, is provided with the metal conducting layer 7; only one side of each COF12, which corresponds to the side of the LCD panel, and both adjacent side of the COF12, are provided with the metal conducting layer 7; thereby, a large number of metal conducting layer materials are saved.

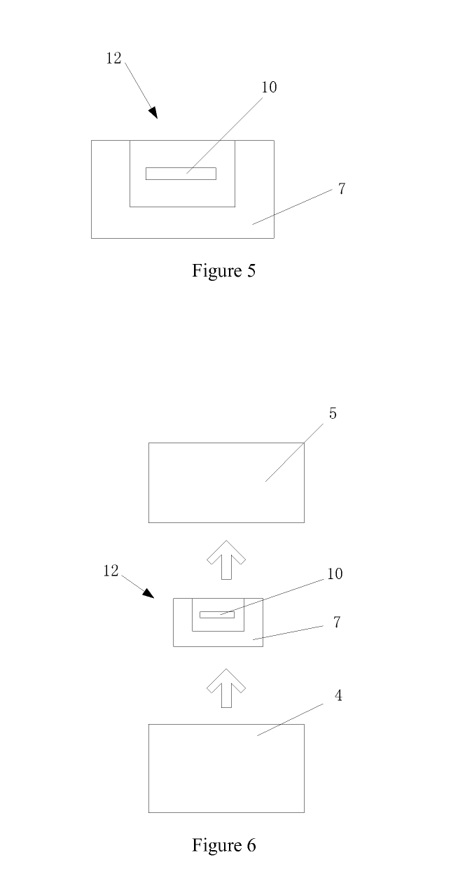

In addition, as shown in FIG. 5, the conducting layers used for discharging the static electricity from the LCD panel are arranged between the LCD panel and the COF during the making process of the LCD; the metal conducting layer 7 can be directly attached to the COF12 when the COF12 is manufactured, i.e. the process step for directly attaching the metal conducting layer 7 to the COF is added when the COF12 is produced, and the metal conducting layer 7 and the integrated circuit 10 (IC) are arranged at both sides of the COF12 respectively; therefore, the metal conducting layer 7 does not need to be added at the post-production process, which simplifies the post production, avoids the added trouble and improves the production efficiency. The FIG. 5 is a schematic diagram of COF12, but the shape of the COF12 is not limited to this Figure. As shown in FIG. 6, the metal conducting layers 7 are arranged at three sides (including one side corresponding to the side of the LCD panel 4 and both adjacent sides) of the COF12, which ensures the good conductive effect and reasonably saves the metal materials due to that only partial metal conducting layer 7 need to be arranged at the sides of PCB5.

Besides the function of static discharge, the metal conducting layer 7 attached to the COF12 is also a good heat conductor capable of dissipating the heat generated by the COF12, so that the surface (corresponding to the IC) of the COF12 with big heat dissipation needs to be totally provided with the metal conducting layer 7, so as to obtain the largest heat dissipation areas; thereby, the heat dissipating efficiency is improved, and the safety of the integrated circuit (IC) and the electronic parts of the COF12 is preferably protected, and the service life of the COF12 is prolonged.

FIG. 4 shows the fourth embodiment of the present invention. As shown in FIG. 4, compared with embodiment 2, the conducting layers arranged at all the COFs at one side of the LCD panel and at the corresponding side of the LCD panel are composed into an integral metal layer, which simplifies the production process, i.e. an integral metal layer is directly attached to the LCD panel without attaching the conducting layers to the COF12 one by one, so that the production process is simplified, and the production efficiency is raised.

In addition, the metal conducting layer 7 corresponding to one side of the LCD panel 4 is a continuous conducting layer, so that the metal conducting layer only needs to be arranged on one COF12 at one side of the LCD panel 4; while, in order to assure the safety, the metal conducting layer needs to be arranged on the whole surface of the COF12.

The above content is detailed description of the present invention by using specific preferred embodiments. However, this present invention is not limited to these specific embodiments. For example, the metal conducting layer 7 is not necessarily to be attached to the LCD panel 4, all attached to the COF12 is also possible as long as the metal conducting layer on the COF12 contacts with the LCD panel; the metal conductive layer is not limited to be arranged at the three sides of the COF12, and can be arranged at one side, both sides or four sides, but also can directly pass through the middle of the pasting surface (relative to the surface of the IC). For the ordinary technical personnel of the technical field of the present invention, on the premise of keeping the concept of the present invention, the technical personnel can also make simple deductions or replacements, and all of which should be considered to belong to the protection scope of the present invention.

1. A LCD, comprising: a LCD panel and one or more COFs arranged at the edge of the LCD panel, wherein conducting layers used for discharging the static electricity from the LCD panel are arranged between the LCD panel and the COF.

2. The LCD of claim 1, wherein said conducting layers are composed into a metal layer.

3. The LCD of claim 1, wherein said conducting layers are arranged at the periphery of the LCD panel, at least one COF is provided with the conducting layer, and the conducting layers at the periphery of the LCD panel are connected with the conducting layers on one or more COFs.

4. The LCD of claim 3, wherein said four conducting layers on one or more COFs are respectively arranged at the sides of the LCD panel.

5. The LCD of claim 1, wherein said conducting layers are arranged between each COF and the LCD panel.

6. The LCD of claim 5, wherein said conducting layers are arranged at the corresponding side of each COF and the LCD panel, and also arranged at both sides adjacent to this corresponding side.

7. The LCD of claim 6, the conducting layers arranged on all the COFs at one side of the LCD panel and the conducting layers at one corresponding side of the LCD panel are composed into an integral metal layer.

8. The LCD of claim 1, wherein said conducting layers are a metal layer covering the whole surface of the COF.

9. The LCD of claim 1, wherein an electronic chip is arranged at one side of each COF, and said conducting layer is arranged at another side of the COF corresponding to the side on which the electronic chip is arranged.

10. A making method of a liquid crystal display (LCD), comprising the steps for installing conducting layers between a LCD panel and a COF, so as to discharge static electricity from the LCD panel.

11. The LCD making method of claim 10, wherein said conducting layers are directly attached to the COF when the COF is manufactured.
